(19) United States
(12) Patent Application Publication
(10) Pub. No.: US 2012/0137534 A1
(43) Pub. Date: Jun. 7, 2012

(54) APPARATUS FOR DRYING CLOTHES

(76) Inventor: Pierce James Barnard, Cherrybrook (AU)

(21) Appl. No.: 12/962,056

(22) Filed: Dec. 7, 2010

(51) Int. Cl. F26B 21/06; F27D 11/00; A47F 7/19

(52) U.S. Cl. 34/72; 211/85.3; 219/385

(57) ABSTRACT

A clothes drying apparatus (1) includes a base (3) adapted for engagement with a lower support surface. A lower housing (7) extends from the base (3). The apparatus also includes a height adjustable extension element (10) having an upper end (11) adapted for engagement with an upper support surface. A selectively releasable locking mechanism (13) is adapted to secure the extension element (10) in adjusted positions such that the apparatus (1) in use extends in a generally vertical orientation between the lower and upper support surfaces. A plurality of support arms (16) extend generally outwardly from the extension element to support clothes (2) for drying. A heater is optionally provided in the lower housing.

### FIELD OF THE INVENTION

The present invention relates generally to an apparatus for drying clothes. The invention has been developed primarily for drying domestic laundry and will be described predominantly in that context. It should be appreciated, however, that the invention is not limited to this particular operating environment. In particular, it is applicable to other textiles, materials or products and may be adaptable to other fields of use.

### BACKGROUND OF THE INVENTION

The following discussion of the prior art is provided in order to place the invention in an appropriate technical context and allow the advantages of it to be more fully appreciated by those skilled in the art. However, it should be understood that any reference to prior art in this specification is not an express or implied admission that such art is widely known or forms part of common general knowledge in the field.

The primary purpose of clothes dryers is to remove moisture, either partially or completely, from clothing or other textiles. One well-known form of clothes dryer is the electric tumble dryer. While these dryers are relatively compact and effective in most weather conditions, they are notoriously inefficient and are characterised by high energy consumption—using up to 15 times the energy of an electric washing machine per cycle. This energy consumption gives rise to significant operating costs in the form of increased electric power bills, as well as adverse environmental impacts flowing from the cumulative impact of excessive energy consumption over sizeable urbanised populations. It is well known, for example, that energy consumption in the residential sector is a significant contributor to greenhouse gas emissions in most developed countries. It is also well known that this form of drying can adversely affect the appearance and significantly shorten the life of clothes, due to shrinkage of, and general wear and tear on, the constituent fabrics.

Line drying of clothes is also known, in both indoor and outdoor environments. For example, the rotary clothes line is a common feature of backyards of many suburban environments. These outdoor clotheslines consume no power and are therefore useful in reducing energy consumption and greenhouse gas emissions. They are also less damaging to clothes over the long term. However, they suffer from a number of inherent disadvantages. Firstly, they require a substantial amount of outdoor space in order to operate effectively, which this is not available in many environments. This is particularly so in densely populated cities, for example, where land is either unavailable or prohibitively expensive, and apartment living is prevalent. This mode of drying is also heavily weather dependent, being ineffective in conditions of rain or snow, and only partially effective in high humidity.

In order to ameliorate some of these limitations, indoor clothes drying racks and lines have also been developed in a wide variety of shapes and configurations, often foldable to facilitate flat storage when not in use. Again, however, they suffer from a number of significant disadvantages. They are typically awkward to handle, especially while juggling wet laundry in one hand and the clothes rack in another. They are also often unstable, particularly when loaded with wet laundry or when positioned in windy locations. Furthermore, they are typically unattractive aesthetically, relatively inefficient in terms of space utilisation, and are often prone to a short effective life due to inferior design, construction or material selection. They are also somewhat dependent upon climatic conditions, being relatively slow to dry clothes, in conditions of low temperature and/or high humidity.

Moreover, many of these problems are likely to become increasingly significant in the future as energy costs rise, population densities increase, land becomes less available, residential space becomes more expensive and sensitivities to environmental impacts are heightened.

It is an object of the present invention to overcome or ameliorate one or more of the disadvantages of the prior art, or at least to provide a useful alternative.

### SUMMARY OF THE INVENTION

Accordingly, in a first aspect, the invention provides a clothes drying apparatus including:

a base adapted for engagement with a lower support surface;

a lower housing;

a height adjustable extension element having an upper end adapted for engagement with an upper support surface;

a selectively releasable locking mechanism adapted to secure the extension element in adjusted positions such that the apparatus in use extends in a generally vertical orientation between the lower and upper support surfaces; and

a plurality of support arms extending generally outwardly to support clothes for drying.

In one preferred embodiment, the lower support surface is a floor and the upper support surface is a ceiling of a room in which the apparatus is intended to be used.

In one embodiment, the support arms are detachable, each preferably incorporating a locating formation adapted for releasable engagement with complementary formations on the extension element.

In one embodiment, the lower housing incorporates the base and preferably also includes a heater adapted to facilitate drying of clothes on the support arms.

In one embodiment, the apparatus further includes an upper housing disposed immediately above and connected to the lower housing. In one embodiment, the upper housing is adapted telescopically to support the extension element, thereby to provide the height adjustment mechanism.

In one embodiment, the locking mechanism includes a plurality of circumferentially spaced apart, axially extending tapered locking fingers surrounding the extension element, and a threaded locking ring. The locking ring is preferably adapted upon rotation to progressively urge the tapered locking fingers into locking frictional engagement with the extension element, thereby to secure the extension element in the adjusted position.

In one embodiment, the apparatus further includes a support frame releasably connected to or adjacent the base. Preferably, the support frame includes four support legs disposed uniformly around the base, and a support ring disposed coaxially around the lower housing. In one embodiment, each support leg includes a support foot adapted for non-slip engagement with the floor, a lower connecting formation adapted for releasable engagement with the lower housing, and an upper connecting formation adapted for releasable engagement with the upper housing.

In one embodiment, the heater includes a heating cartridge comprising an electrical heating element, a fan, a heat deflecting cone, and a perforated outer casing. The heating cartridge is preferably arranged such that air heated by the heating element is directed outwardly through the perforated casing under the combined action of the fan in the deflecting cone, such that the hot air emanating from the heating cartridge rises upwardly under convection to dry the clothes on the support arms extending radially outwardly from the extension element. In one embodiment, the apparatus also includes a filter unit adapted to filter air drawn into the heating cartridge.

In some embodiments, additional support arms may also be positioned on the upper housing and/or the lower housing. In some embodiments, multiple heating cartridges, and/or multiple extension elements may also be provided.

In one embodiment, two or more clothes drying apparatus maybe provided together with intermediate drying lines, drying arms or drying rods extending between them, to accommodate additional clothes.

In one embodiment, the apparatus includes a biasing mechanism operable to provide positive compressive engagement between the upper end of the extension element and the upper support surface. The biasing mechanism may take a number of forms including a spring, a selectively operable camming mechanism, an over-centring mechanism or the like, configured to apply a residual compressive engagement force on the upper and lower support surfaces after the locking mechanism has been activated, to help stabilise the apparatus in situ.

In some embodiments, complementary locating formations may be additionally or alternatively be provided on the upper and/or lower support surfaces for enhanced stability and security.

In some embodiments, a control system is provided to deactivate the heater after a predetermined (and optionally user-adjustable) period of time has elapsed and/or when a predetermined (and optionally user-adjustable) ambient or internal threshold temperature has been reached.

In some embodiments, the control system optionally also includes safety cut-out switches adapted for automatic deactivation of the heater in the event of smoke, fire, excessive temperature, excessive operation time, electrical short-circuit or other predetermined safety criteria.

According to a second aspect, the invention provides a clothes drying apparatus including:

a base adapted for engagement with a lower support surface;

a lower housing;

a height adjustable extension element;

a selectively releasable locking mechanism adapted to secure the extension element in adjusted positions such that the apparatus in use extends in a generally vertical orientation; and

a plurality of support arms extending generally outwardly to support clothes for drying.

### BRIEF DESCRIPTION OF THE DRAWINGS

Preferred embodiments of the invention will now be described, by way of example only, with reference to the accompanying drawings in which:

FIG. 1 is a perspective view of a clothes drying apparatus according to the invention;

FIG. 2 is an enlarged perspective view of the lower section of the clothes drying apparatus of FIG. 1, showing the base, lower housing and support legs in more detail;

FIG. 3 is an enlarged cross-sectional side elevation view, showing the connection between the base and the lower housing in more detail;

FIG. 4 is an enlarged cross-sectional side elevation view, showing the upper end of the extension element and the associated top plug in more detail;

FIG. 5A is an enlarged cross-sectional side elevation view of the locking mechanism on the upper housing, around the extension element;

FIG. 5B is a side elevation view of the locking mechanism shown in FIG. 5A;

FIG. 6 is a cross-sectional side elevation of a portion of the extension element showing slots for releasably mounting the support arms;

FIG. 7 is a perspective view showing the locking mechanism on the upper housing, with the extension element removed, and a detached support arm;

FIG. 8 is a perspective view showing the support legs of the lower support frame adapted for engagement with the lower housing;

FIG. 9 is a perspective view of the lower housing with the perforated casing removed, to reveal the heating cartridge located within the lower housing;

FIG. 10 is an enlarged perspective view showing the heater cartridge removed from the lower housing; and

FIG. 11 is a side elevation view of the air intake filter unit mounted within the lower housing.

### PREFERRED EMBODIMENTS OF THE INVENTION

Referring to the drawings, the invention provides a clothes drying apparatus 1 particularly suited for drying domestic laundry 2 in relatively confined spaces. The apparatus 1 will be described hereinafter with reference to its use in an interior room of a residential dwelling such as a house or apartment. However, it will be appreciated that the apparatus is not limited to this specific application and could readily be used in a wide variety of other textile drying applications, including commercial applications, and could also be adapted for use in external environments.

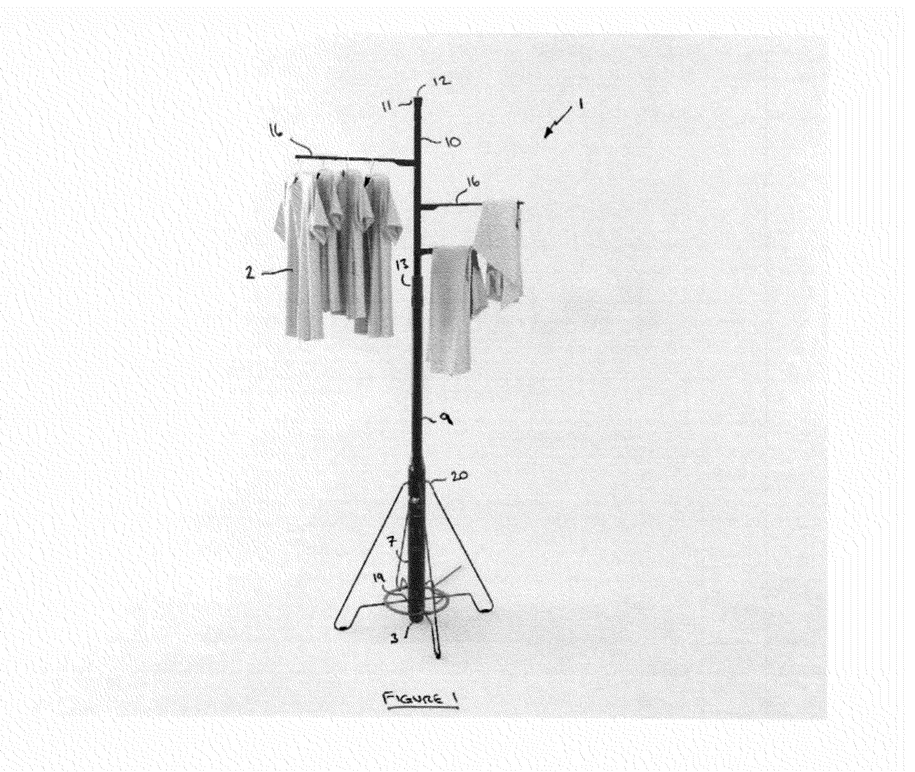

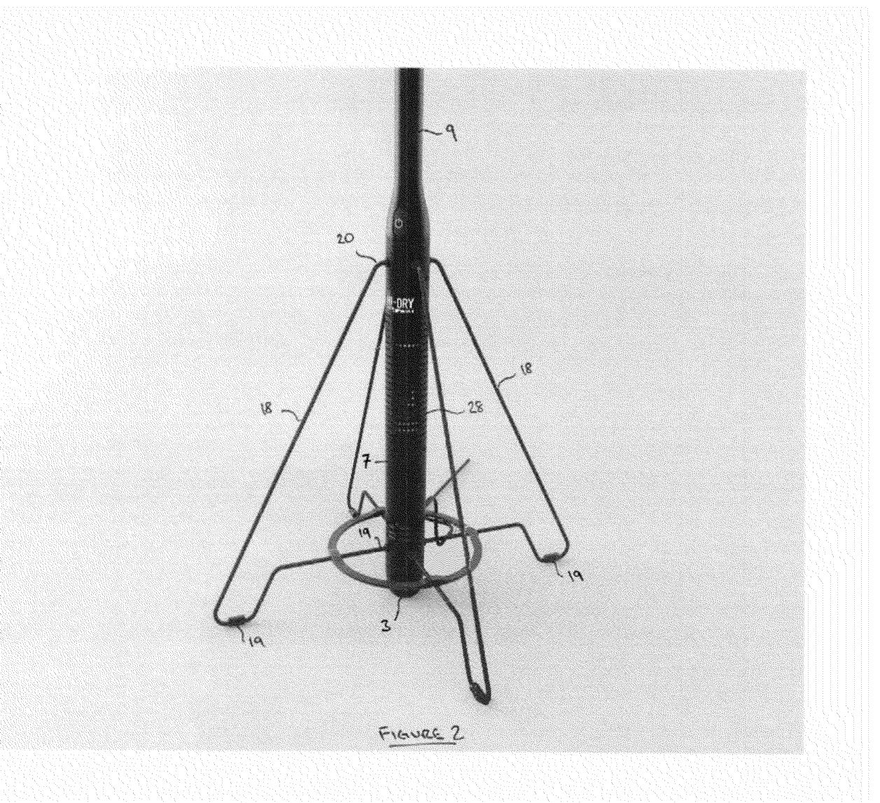

As shown in FIGS. 1 and 2, the clothes drying apparatus 1 takes the form of a generally elongate structure which, in normal use, extends in a substantially vertical orientation between a lower support surface such as a floor (not shown) and an upper support surface such as a ceiling (also not shown) of a room within a house or apartment in which the apparatus is intended to be used.

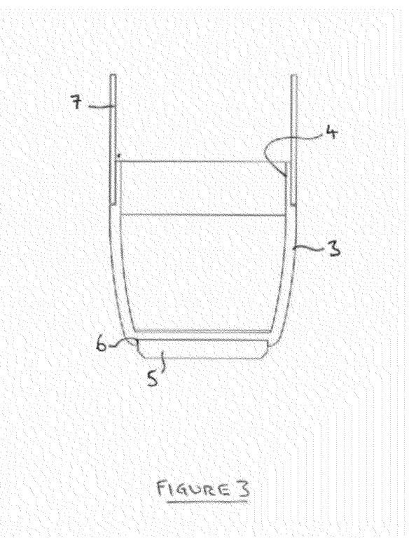

The apparatus 1 includes a base 3 adapted for engagement with the floor of the room. As most clearly shown in FIG. 3, the base 3 comprises a plug-type component having an upper, externally threaded portion 4 and a floor-engaging, friction enhancing support pad 5 for inhibiting undesirable sliding movement between the base 3 and the floor, in use.

The base 3 is preferably formed as an injection moulded polypropylene component, the underside of which incorporates a receiving formation such as a cavity 6, adapted to press-fittingly receive and locate the support pad 5. The support pad 5 is preferably a compression moulded ethylene-vinyl acetate component.

A lower housing 7 in the form of an aluminium tube having a lower, internally threaded portion 8 is threadedly connected to the base 3 so as to extend upwardly therefrom. As will be described in greater detail below, the threaded engagement between the base 3 and lower housing 7 advantageously allows the base 3 to be readily detached to enable access to, and cleaning of, components housed within the lower housing.

As most clearly shown in FIGS. 1 and 2, the apparatus further includes an elongate, generally tubular upper housing 9 disposed immediately above and connected to the lower housing 7.

A height adjustable extension element in the form of an elongate aluminium pole 10 is supported within the upper housing 9. The extension element 10 is adapted for telescopic inter-engagement with the upper housing 9 to provide a height adjustment mechanism for the apparatus.

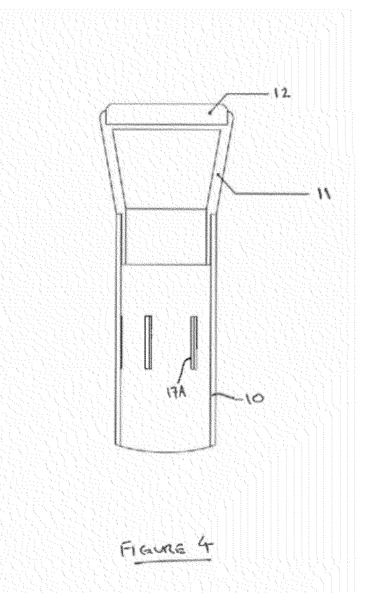

With reference to FIG. 4, it will be seen that the upper end of the extension element 10 terminates in a removable top plug 11 which is adapted for engagement with the ceiling of the room in which the apparatus is used. The top plug 11 incorporates a friction enhancing grip pad 12 which is press-fitted into a top recess of the main body of the plug. As most clearly shown in FIG. 4, the top plug 11 is inserted into an open upper end of the extension pole 10, preferably with an interference fit to prevent inadvertent removal and to inhibit undesirable rotation between the plug 11 and the extension pole 10 in situ.

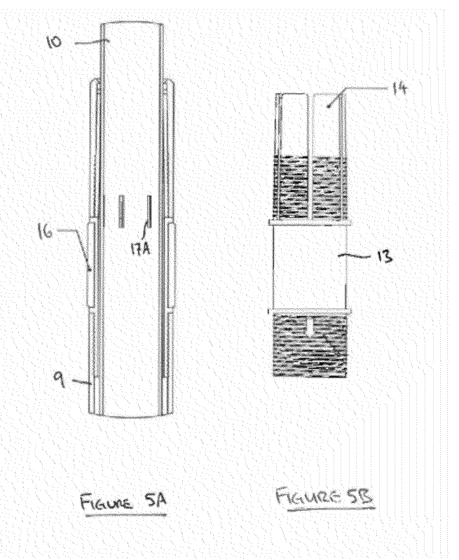

To secure the extension element 10 in adjusted positions, a selectively releasable locking mechanism 13 is connected to the upper end of the upper housing 9. As most clearly shown in FIGS. 5A and 5B, the locking mechanism 13 includes a plurality of circumferentially spaced apart, axially extending tapered locking fingers 14 surrounding the extension element 10. A threaded locking ring 16 is adapted upon rotation to progressively urge the tapered locking fingers 14 into frictional engagement with the extension element 10, to secure the extension element 10 in the adjusted position with respect to the upper housing.

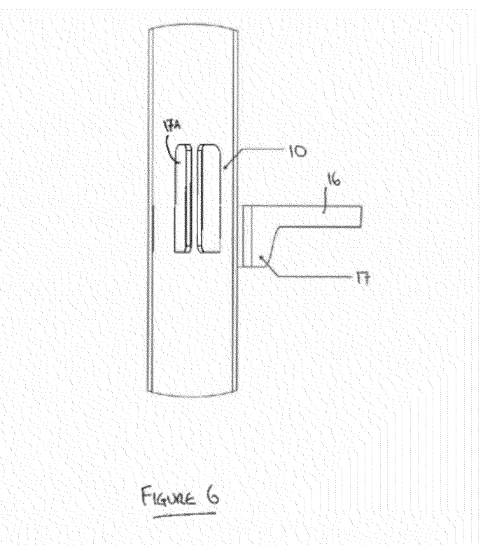

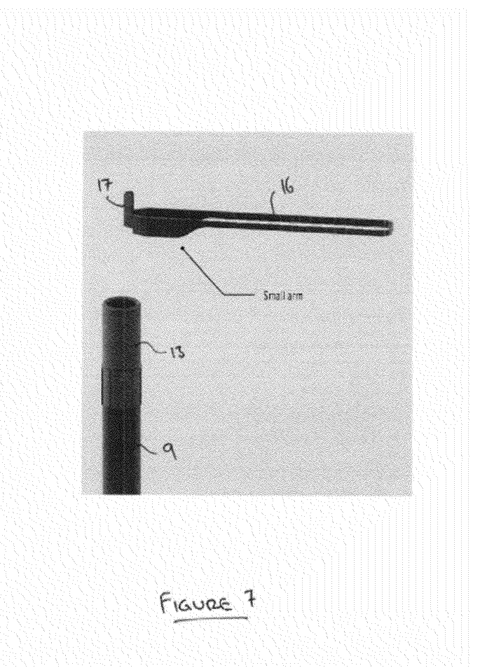

As best seen in FIGS. 1, 6 and 7, the apparatus further includes a plurality of detachable support arms 16, which in use extend radially outwardly from the extension pole 10 to support clothes 2 for drying. As most clearly shown in FIG. 7, each support arm 16 has a location formation in the form of a lug 17 for detachably mounting the arm 16 to the extension pole 10, by means of complementary slots 17A formed in the extension pole. Although not shown in the illustrated embodiment, it will be appreciated by those skilled in the art that other embodiments may incorporate additional support arms positioned on the upper housing and/or the lower housing. It will also be appreciated that a variety of different locating formations or mechanisms for the support arms may alternatively be used.

In the illustrated embodiment, as most clearly shown in FIGS. 1, 2 and 8, the drying apparatus further includes a detachable support frame, preferably comprising four support legs 18 disposed uniformly around the base 3.

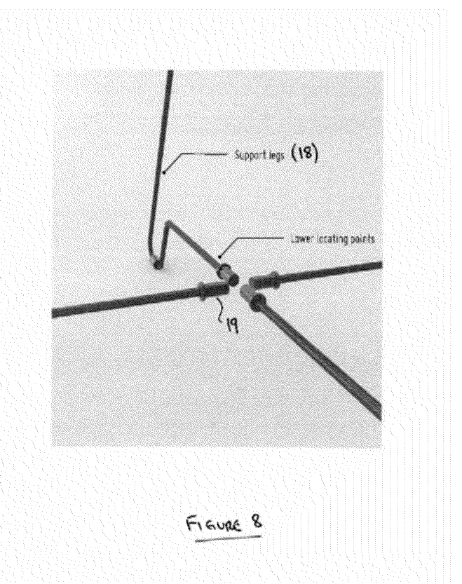

Each support leg 18 is formed from a metal rod, preferably formed from steel or aluminium but other materials such as plastic, fibreglass or carbon fibre may alternatively be used. Each leg has a lower end 19 adapted for engagement with the lower housing 7 and an upper end 20 adapted for engagement with the upper housing 9. The lower and upper housings (7, 9) respectively have four circumferentially spaced sockets 21 for releasably receiving the lower and upper ends (19, 20) of the legs 18. To improve the structural integrity of the support frame, the ends (19, 20) of each leg 18 are preferably fitted with a magnetic plug-type element. An oppositely poled magnet is associated with each socket 21 to hold the respective support leg in place. As most clearly shown in FIG. 8, each support leg 18 also includes a rubber support foot 19 adapted for non-slip engagement with the floor.

As best seen in FIG. 2, the support legs 18 are held in fixed relative relationship to each other by an annular support ring 22 disposed coaxially around the lower housing 7. The support ring 22 has four notches 23 adapted for snap-fitting engagement with the respective support legs.

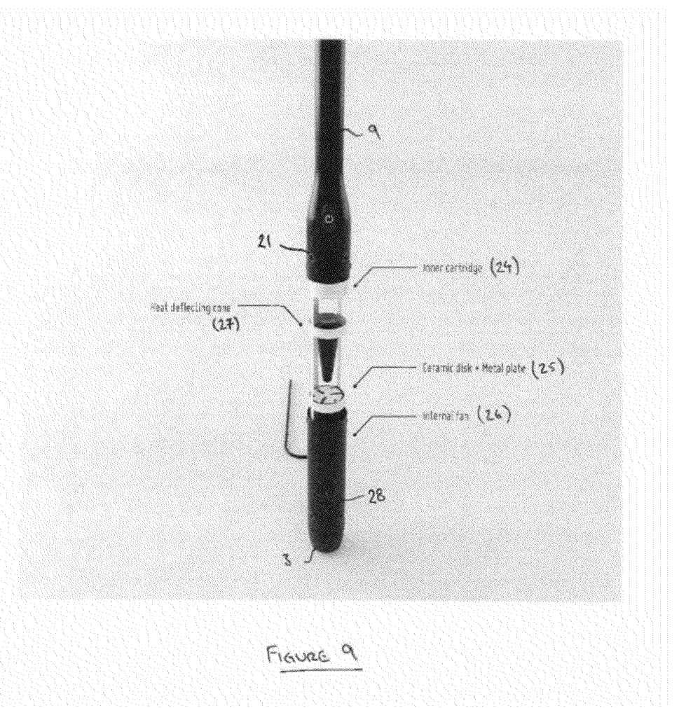

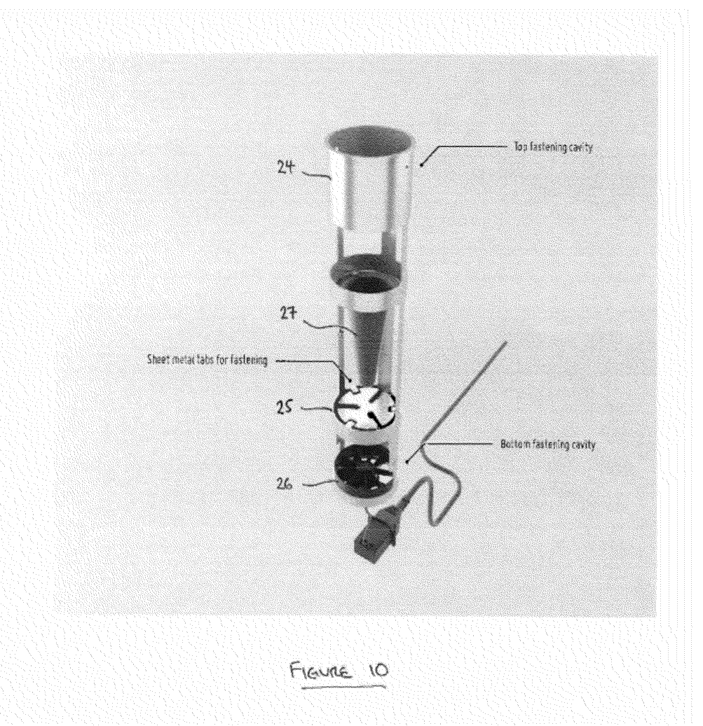

In the illustrated embodiment, the lower housing 7 contains several electrical components including a heater adapted to facilitate drying of clothes hung on the support arms. With reference to FIGS. 9 and 10, the heater includes a heating cartridge 24 comprising an electrical heating element 25, a fan 26, a heat deflecting cone 27, and a perforated outer casing 28 (removed in FIG. 9 to reveal the internal elements of the heating cartridge but clearly visible in FIG. 2).

The heating cartridge 8 is arranged such that air heated by the heating element 25 is directed upwardly and outwardly through the perforated casing 28 under the combined action of the fan 10 and the deflecting cone 27. The hot air emanating from the heating cartridge 24 then rises upwardly under convection and disperses so as to dry the clothes 2 on the support arms 16 extending radially outwardly from the extension pole 10.

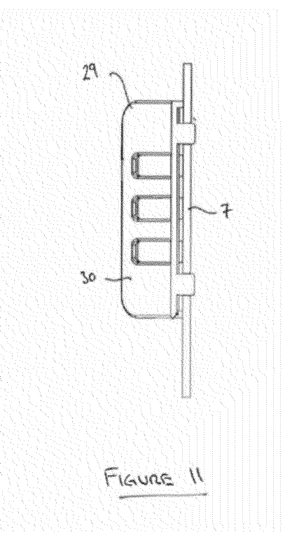

The lower housing 7 also incorporates an air intake opening 28 and an associated air intake filter unit 29, as best seen in FIG. 11, for inhibiting dust and other small particles from entering the lower housing 7 via the air intake opening 28. The air intake filter unit 29 comprises a polypropylene housing 30 configured for releasable snap-locking attachment within the lower housing.

The invention in various embodiments thus overcomes a number of problems. Because of its generally upright orientation, it is highly space-efficient, requiring only a small “footprint” and is therefore suitable for even highly confined internal spaces. The adjustment mechanism makes it not only readily adaptable for use in rooms of different heights, but also able to optimally utilise all of the available height for drying. In conditions amenable to natural drying, the heater need not be activated, in which case no power at all is required. Even when the heater is activated to accelerate the drying process, the relatively high efficiency inherent in the overall design, relying heavily on natural convection for air circulation, results in minimal power consumption. By firmly engaging both the floor and the ceiling of the room, the apparatus is inherently stable and secure even when fully loaded with laundry, notwithstanding its compact footprint. By removing the lower support frame and the drying arms, the apparatus can be stored in a highly compact configuration when not in use, and then very quickly reassembled when required. It is ergonomic to use and aesthetically pleasing. In these and other respects, at least in its preferred embodiments, the invention thus represents a practical and commercially significant improvement over the prior art.

Although the invention has been described with reference to specific examples, it will be appreciated by those skilled in the art that the invention may be embodied in many other forms.

1. A clothes drying apparatus including:
a base adapted for engagement with a lower support surface;
a lower housing;
a height adjustable extension element having an upper end adapted for engagement with an upper support surface;
a selectively releasable locking mechanism adapted to secure the extension element in adjusted positions such that the apparatus in use extends in a generally vertical orientation between the lower and upper support surfaces; and
a plurality of support arms extending generally outwardly to support clothes for drying.

2. A clothes drying apparatus according to claim 1, wherein the lower support surface is a floor and the upper support surface is a ceiling of a room.

3. A clothes drying apparatus according to claim 1, wherein the support arms are detachable, and wherein each arm incorporates a locating formation adapted for releasable engagement with a complementary formation on the extension element.

4. A clothes drying apparatus according to claim 1, wherein the lower housing incorporates the base and also includes a heater adapted to facilitate drying of clothes on the support arms.

5. A clothes drying apparatus according to claim 4, wherein the heater includes a heating cartridge comprising an electrical heating element, a fan, a heat deflecting cone, and a perforated outer casing.

6. A clothes drying apparatus according to claim 5, wherein the heating cartridge is arranged such that air heated by the heating element is directed outwardly through the perforated casing under the combined action of the fan and the deflecting cone, such that the hot air emanating from the heating cartridge rises upwardly under convection to dry the clothes on the support arms.

7. A clothes drying apparatus according to claim 1, further including an upper housing disposed immediately above and connected to the lower housing.

8. A clothes drying apparatus according to claim 7, wherein the upper housing is adapted telescopically to support the extension element, thereby to provide the height adjustment mechanism.

9. A clothes drying apparatus according to claim 1, wherein the locking mechanism includes a plurality of circumferentially spaced apart, axially extending tapered locking fingers surrounding the extension element, and a threaded locking ring operatively engageable with the tapered locking fingers.

10. A clothes drying apparatus according to claim 9, wherein the locking ring is adapted upon rotation to progressively urge the tapered locking fingers into frictional engagement with the extension element, thereby to secure the extension element in the adjusted position.

11. A clothes drying apparatus according to claim 1, wherein the apparatus further includes a support frame releasably connected to or adjacent the base.

12. A clothes drying apparatus according to claim 11, wherein the support frame includes a plurality of support legs disposed uniformly around the base.

13. A clothes drying apparatus according to claim 12, wherein each support leg includes a support foot adapted for non-slip engagement with the floor, a lower connecting formation adapted for releasable engagement with the lower housing, and an upper connecting formation adapted for releasable engagement with the upper housing.

14. A clothes drying apparatus according to claim 1, further including a filter unit adapted to filter air drawn into the heating cartridge.

15. A clothes drying apparatus according to claim 1, wherein additional support arms are adapted to be positioned on the lower housing.

16. A clothes drying apparatus according to claim 7, wherein additional support arms are adapted to be positioned on the upper housing.
